(19) United States
(12) Patent Application Publication
(10) Pub. No.: US 2025/0019833 A1
(43) Pub. Date: Jan. 16, 2025

(54) METHOD OF MANUFACTURING A CATALYST MEMBRANE, CATALYST MEMBRANE OBTAINED THEREBY AND USE THEREOF

(71) Applicant: VSPARTICLE HOLDING B.V., Delft (NL)

(72) Inventors: Tobias Vincent Pfeiffer, Delft (NL); Wilbert Lintle Vrijburg, Delft (NL); Michail Tsampas, Delft (NL); Foteini Pountzi, Delft (NL); Sofia Dimitriadou, Delft (NL)

(73) Assignee: VSPARTICLE HOLDING B.V., Delft (NL)

(21) Appl. No.: 18/712,102

(22) PCT Filed: Nov. 18, 2022
(86) PCT No.: PCT/EP2022/082488

§ 371 Date: May 21, 2024

(30) Foreign Application Priority Data
Nov. 24, 2021 (NL) 2029898

(51) Int. Cl. C23C 24/04; B22F 1/054; B22F 9/14; C25B 9/23; C25B 11/042; C25B 13/08

(52) U.S. Cl. CPC C23C 24/04; B22F 1/054; B22F 9/14; C25B 9/23; C25B 11/042; C25B 13/08; B22F 2301/25; B22F 2998/10; B22F 2999/00

(57) ABSTRACT

A method of manufacturing a catalyst membrane includes providing a membrane, generating an aerosol of catalyst nanoparticles by spark ablation, and directing the aerosol of catalyst nanoparticles towards a first side of the membrane such that the catalyst nanoparticles are deposited onto the membrane thereby forming the catalyst membrane. A catalyst membrane includes a membrane and catalyst nanoparticles attached directly to the membrane in a binder-free manner.

The present invention relates to a method of manufacturing a catalyst membrane by generating an aerosol of catalyst nanoparticles. The present invention further relates to a catalyst membrane produced via the method wherein the membrane comprises catalyst nanoparticles attached to the membrane, a membrane electrode assembly comprised of the catalyst membrane, and use of the catalyst membrane.

Hydrogen will play a pivotal role in the transition towards low-carbon economy. In the establishment of a global hydrogen market, water electrolysis is expected to be vital. Among the various water electrolysis technologies, proton exchange membrane (PEM) electrolysis holds promise due to its efficiency, compact design and potential dynamic operation. However, PEM electrolysers rely on the use of scarce and expensive noble metal catalysts (Pt-based catalysts at the cathode, Ir-based catalysts at the anode) and this imposes limitations to market penetration.

Electrocatalysis has become an exciting and fast-paced branch of catalysis in recent years, as researchers explore new methods and materials to catalyse reactions related to energy storage and chemical synthesis. Significant advances have been made in developing proton exchange membrane (PEM) water electrolysers, with Ir-based electrodes among the most active and stable electrocatalysts to promote the sluggish oxygen evolution reaction (OER). At present, noble metal-based materials (Pt, Ir, Ru, Rh) are the most active for both hydrogen evolution reaction (HER) and oxygen evolution reaction (OER). In order to make these electrochemical processes scalable and commercially viable, their noble metal contents must be lowered or replaced by cheaper alternatives such as Ni, Fe, Co and Mn (amongst others). Methods to rapidly and reproducibly synthesize a wide variety of mono/bi/multi-metallic electrocatalysts are therefore not only highly desirable, but crucial for today's researchers to prepare and compare novel electrocatalysts to meet the modern day energy and chemical challenges.

Furthermore, Ir-based electrodes are currently synthesised via a range of multi-step approaches. These steps may include the preparation of a “catalyst ink” from pre-synthesised Ir nanoparticles and subsequently applying this dispersion on the desired substrate (e.g. Ti-felt, carbon). The latter step is typically realized either by air-assisted spray deposition either directly on the diffusion substrate or on the membrane or the decal transfer technique. Reactive spray deposition of Ir layers and magnetron sputtering have been reported as alternatives to the conventional techniques for catalyst coated membranes (CCM) preparation. Ideally and in order to minimize Ir loadings, the deposition should result to uniform catalyst layers with reduced Ir packing density. In addition, colloidal Ir nanoparticles may also prepared and deposited on a substrate. Such methods require multiple well-executed steps to obtain active electrocatalysts. Moreover, employing colloidal nanoparticles requires aggressive ligand-removal steps to expose the Ir-based nanoparticle surface. Simplifying the electrode synthesis step, to reproducibly obtain active Ir-based electrocatalysts is therefore highly desired.

Significant developments have been made lately in relation to cathodic electrocatalysts. In particular, developments have been made lately in reducing the platinum group metals (PGM) dependence in relation to cathodic electrocatalysis for PEM water electrolysis. Studies have shown that either by implementing noble-metal-free electrocatalysts (e.g. MoS₂, CoP, FeP, NiP₂-catalysts) or by decreasing the Pt loadings by a factor of ten, the performance of PEM water electrolysers can still be sufficiently high. However, enabling similar success stories in relation to anodic electrocatalysts remains the main challenge for PEM water electrolysers. To reduce Ir loadings and thus to reduce the Ir-specific power density, literature studies have been mainly focused on maximizing the Ir dispersion by using high surface area supports (TiO₂, TiC, TaC).

Considering the above, there is a need in the art for an improved method for rapid, scalable, and cost effective production of mono/bi/multi-metallic electrocatalysts. Furthermore, there is a need in the art for reproducible, affordable, high quality, uniform and thin mono/bi/multi-metallic electrocatalysts.

It is an object of the present invention, amongst other objects, to address the above need in the art. The object of present invention, amongst other objects, is met by the present invention as outlined in the appended claims.

Specifically, the above object, amongst other objects, is met, according to a first aspect, by the present invention by a method of manufacturing a catalyst membrane or catalyst coated membrane, the method comprising the steps of;
providing a membrane;
generating an aerosol of catalyst nanoparticles by spark ablation;
directing the aerosol of catalyst nanoparticles towards a first side of the membrane such that the catalyst nanoparticles are deposited onto the membrane thereby forming the catalyst membrane or catalyst coated membrane.

The method of present invention provides low nanoparticle (e.g. metallic nanoparticles such as Ir nanoparticles) loadings by implementing an alternative catalyst layer manufacturing techniques in contrast to the conventional method for developing catalyst coated membranes (CCMs) based on a process which involves the catalyst synthesis by generating an aerosol of catalyst nanoparticles, and the application of the catalyst nanoparticles onto the membrane. The method of present invention employs a nanoparticle deposition technique comprising gas-phase nanoparticle aerosol printing, wherein the nanoparticle aerosols are being produced via spark ablation, to produce CCMs with low nanoparticle loadings compared to the current state-of-the-art, thereby driving down the capital costs of PEM water electrolysis without compromising in activity or stability. Beneficially, there is no binder required to attach the nanoparticles to the membrane. In this way, the transport of the produced ions from the catalyst towards the membrane does not require passage through or along a binder, which may cause reduced transport qualities for ions such as hydrogen ions, hydronium or hydroxide and/or reduced electrical conductivity (electron transport). The produced nanoparticles are also surfactant-free, preferably surfactant free Ir nanoparticles. Using the method of present invention, Ir was deposited on a Nafion 115 polymer exchange membrane, with the final CCMs being representative of industrial electrolysers.

According to a preferred embodiment, the present invention relates to the method of manufacturing a catalyst membrane, wherein the spark ablation is performed by at least one spark generator. The method of present invention includes a gas-phase method, i.e. spark ablation (or spark discharge) to generate clean, surfactant and/or ligand-free nanoparticles with having a particle size below 10 nm. Optionally, the at least one spark generator may be used in series and/or parallel, enabling a higher throughput of the printer and/or mixing in of nanoparticles of another composition, e.g. as co-catalyst.

According to another preferred embodiment, the present invention relates to the method of manufacturing a catalyst membrane, wherein the membrane is an ion conducting polymer, wherein preferably the membrane is configured to conduct hydrogen ions, hydroxide or hydronium ions. Preferably, the ion conducting membrane is a proton exchange membrane selected from the group consisting of polysulfonic acid polymers, perfluorocarbonsulfonic acid polymers, polyacrylic acid polymers, preferably perfluorocarbonsulfonic acid polymers and polysulfonic acid polymers. The ion conducting polymer may for instance be a sulfonated tetrafluoroethylene based fluoropolymer-copolymer, such as the polymer commonly known under the trade name Nafion.

According to another embedment, the ion conducting membrane is an anion exchange membrane. According to yet another preferred embodiment, the present invention relates to the method of manufacturing a catalyst membrane, further comprising, after generating the aerosol of catalyst nanoparticles, allowing the aerosol of catalyst nanoparticles to pass through a nozzle, wherein the directing of the aerosol of catalyst nanoparticles towards the membrane is directing the aerosol of catalyst nanoparticles passed through the nozzle towards the membrane.

According to a preferred embodiment, the present invention relates to the method of manufacturing a catalyst membrane, wherein the aerosol of catalyst nanoparticles is accelerated through the nozzle into a vacuum downstream of the nozzle. The nanoparticle aerosols produced by spark ablation can be directly deposited onto a substrate (e.g. Nafion 115 polymer) using inertial impaction. This is achieved by accelerating the nanoparticle aerosol through a nozzle that is directed at the substrate. A pressure difference, introduced by keeping the substrate under rough vacuum (approximately 1 mbar), is the driving force that accelerates the nanoparticle aerosol through the nozzle. Inertial impaction results in adhesion of the nanoparticles to the substrate without the need for a binder, preserving the purity/cleanliness of the particles. Surprisingly, and advantageously, this adhesion is sufficiently strong to prevent the catalyst nanoparticles from washing away under typical operation conditions. By securing the substrate on an XY (Z)-stage, the nanoparticles are efficiently patterned onto the substrate. This approach enables the reproducible production of CCMs is a single step (in contrast with the conventional methods), and also leads to the production of high-quality and uniform thin catalyst layers.

According to yet another preferred embodiment, the present invention relates to the method of manufacturing a catalyst membrane, wherein a gas pressure upstream of the nozzle is in the range of 0.8 to 1.4 bar, preferably 0.9 to 1.3 bar, more preferably 1 to 1.2 bar. Operating the spark generator at higher pressures tends to increase mass output and particle size, which is beneficial for the throughput of the printer. The described pressure ranges have the benefit of an increased mass output, while membranes are produced with good performance.

According to another preferred embodiment, the present invention relates to the method of manufacturing a catalyst membrane, wherein the pressure of the vacuum downstream of the nozzle is in the range of 0.1 to 4 mbar, preferably 0.5 to 2.5 mbar, more preferably 1 to 2 mbar. The pressure of the vacuum downstream of the nozzle regulates the kinetic energy of the nanoparticles depositing on the membrane, and the preferred pressures are high enough to prevent damage during production of the membrane, and low enough to enable sufficient adhesion of the catalyst nanoparticles to avoid said nanoparticles washing away during operation.

According to yet another preferred embodiment, the present invention relates to the method of manufacturing a catalyst membrane, wherein the pressure at the inlet of the nozzle is below 900 mbar, preferably below 800 mbar, more preferably below 700 mbar.

In the method, virtual impactors (big particle filter/low pass filter) may be used to remove micron sized debris that may be present in the aerosol. The virtual impactors may be positioned upstream of the nozzle, and/or adjacent to the inlet of the nozzle. Reducing the pressure in the virtual impactor to the above noted pressures improves the cut-off between big and small particles.

According to a preferred embodiment, the present invention relates to the method of manufacturing a catalyst membrane, wherein the catalyst nanoparticles are attached directly to the membrane in a binder-free manner.

According to another preferred embodiment, the present invention relates to the method of manufacturing a catalyst membrane, wherein the catalyst nanoparticles are deposited by inertial impaction onto the membrane.

When manufacturing the membrane, it is preferred to keep the substrate under rough vacuum (approximately 1 mbar) the nanoparticle aerosol accelerates through the nozzle and inertial impaction results in adhesion of the nanoparticles to the substrate without the need for a binder, preserving the purity/cleanliness of the particles.

According to yet another preferred embodiment, the present invention relates to the method of manufacturing a catalyst membrane, wherein the catalytic nanoparticles are comprised of one or more elements selected from the group consisting of Ir, Pt, Ru, Rh, Au, Ag, Ni, Fe, Co, Ti, C, Mo and Mn and/or oxides thereof. This may include combinations of the listed metal elements with metal oxides of the listed elements.

According to another preferred embodiment, the present invention relates to the method of manufacturing a catalyst membrane, wherein the catalytic nanoparticles are comprised of iridium or iridium oxide.

According to a preferred embodiment, the present invention relates to the method of manufacturing a catalyst membrane, wherein the catalyst nanoparticles are amorphous nanoparticles having an average particle size in the range of 0.5 nm to 10 nm, preferably 1 nm to 7 nm, more preferably 1.5 to 3 nm, most preferably 2 to 2.5 nm. Particle sizes and size distribution was confirmed by Transmission electron microscopy (TEM) of Ir nanoparticles prepared via spark ablation according to the method of present invention.

According to another preferred embodiment, the present invention relates to the method of manufacturing a catalyst membrane, wherein the iridium is deposited such that a catalytic layer is formed having a mass per unit area in the range of 0.2 to 1.8 mg Ir/cm², preferably 0.4 to 1.2 mg Ir/cm², most preferably 0.4 to 0.8 mg Ir/cm². Result show that high quality catalyst membranes are obtained within the claimed range. More mass per unit area would result in more expensive membranes but also lower quality membranes, less mass per unit area would result in lower quality membranes in view of present CCMs on the market. Taking into account the demands for practical application, for operation at a specific current density, the applied potential, the specific electricity consumption and the Ir-specific power density should be as low as possible, while the energy efficiency should be high. Based on these criteria, the CCMs produced via the method of present invention with Ir loading of 0.4 and 0.8 mg/cm² were identified as the most promising.

According to yet another preferred embodiment, the present invention relates to the method of manufacturing a catalyst membrane, wherein the aerosol of catalytic nanoparticles is passed through the filter before passing through the nozzle. Preferably the generated aerosol of catalytic nanoparticles is passed through a filter, preferably a low pass filter, to remove particles larger than a threshold size from the aerosol. The threshold size preferably lies in the range of 0.1 μm-10 μm, more preferably the threshold size is 0.1 μm.

According to a preferred embodiment, the present invention relates to the method of manufacturing a catalyst membrane, further comprising attaching a porous transport layer to the first side of the catalyst membrane, wherein the porous transport layer is electrically conductive, thereby forming a membrane electrode assembly. The porous transport layer improves the mobility of electrons and gaseous species across the membrane surface.

According to an embodiment, the deposited catalyst iridium or iridium oxide nanoparticles have a layer thickness in the range of 1-3 μm and/or or a layer thickness density equal to or larger than 3.9 gIr/cm³, preferably in the range of 3.9-10 g Ir/cm3, more preferably 3.9-8.0 g Ir/cm3. These high Ir densities allows the use of thinner catalyst films, reducing transport limitations in the direction perpendicular to the plane of the membrane.

In general, the deposited layers of catalyst nanoparticles according to the invention, while relatively compact, have a surprisingly high availability of catalytically active sites. This enables the use of thinner catalyst nanoparticle layers, which in turn reduces the series resistance of the membrane.

In the present patent disclosure, the term “catalyst membrane” may be interchanged with “catalyst coated membrane”

The present invention, according to a second aspect, relates to a catalyst membrane manufactured according to the method of present invention as disclosed above.

According to another preferred embodiment, the present invention relates to the catalyst membrane, comprising a membrane and catalyst nanoparticles attached directly to the membrane in a binder-free manner.

According to yet another preferred embodiment, the present invention relates to the catalyst membrane, wherein the membrane is an ion conducting membrane, preferably a proton conducting membrane. Preferably, the ion conducting membrane is a proton exchange membrane selected from the group consisting of polysulfonic acid polymers, perfluorocarbonsulfonic acid polymers, polyacrylic acid polymers, preferably perfluorocarbonsulfonic acid polymers and polysulfonic acid polymers. The ion conducting polymer may for instance be a sulfonated tetrafluoroethylene based fluoropolymer-copolymer, such as the polymer commonly known under the trade name Nafion.

According to another embodiment, the ion conducting membrane is an anion exchange membrane.

According to another preferred embodiment, the present invention relates to the catalyst membrane, wherein the catalyst nanoparticles are metal nanoparticles or metal oxide nanoparticles. Preferably the catalyst nanoparticles are comprised of one or more elements selected from the group consisting of Ir, Pt, Ru, Rh, Au, Ag, Ni, Fe, Co, Ti, C, Mo and Mn and/or oxides thereof. This may include combinations of the listed metal elements with metal oxides of the listed elements. Most preferred catalyst nanoparticles comprised of iridium, iridium oxide or a combination thereof.

According to a preferred embodiment, the present invention relates to the catalyst membrane, wherein the catalytic layer comprises iridium with a mass per unit area in the range of 0.2 to 1.8 mg Ir/cm², preferably 0.4 to 1.2 mg Ir/cm², most preferably 0.4 to 0.8 mg Ir/cm².

According to another preferred embodiment, the present invention relates to the catalyst membrane, wherein the catalyst nanoparticles have an average particle size in the range of 0.5 nm to 10 nm, preferably 1 nm to 7 nm, more preferably 1.5 to 3 nm, most preferably 2 to 2.5 nm. The smaller the particle, the larger the specific surface area becomes. The reduced particle size in respect to the prior art particles size of the catalyst nanoparticles further enables the formation of a catalytic layer with a higher density of catalyst nanoparticles and having increased porosity, allowing the use of a thinner catalytic layer for preventing mass transport limitation of the catalyst membrane.

According to yet another preferred embodiment, the present invention relates to the catalyst membrane, wherein the catalyst nanoparticles are amorphous nanoparticles. Catalyst nanoparticles used in the prior art are generally crystalline nanoparticles, this in contrast to the amorphous nanoparticles of present invention which provide an improved catalytic surface/action. The use of spark ablation to make iridium (oxide) nanoparticles as in preferred embodiments of the present invention is advantageous because it amorphous nanoparticles are formed.

It will be understood that any features and/or advantages of the above noted second aspect are readily implementable and/or applicable in the method of the first aspect and vice versa. The same hold for the below further aspects.

The present invention, according to a further aspect, relates to a membrane electrode assembly (MEA) comprising the catalyst membrane of present invention as described above and/or below. Preferably the membrane electrode assembly is configured for water electrolysis.

The present invention, according to a further aspect, relates to the use of a catalyst membrane or membrane electrode assembly as disclosed herein for water electrolysis.

The present invention will be further detailed in the following examples and figures wherein:

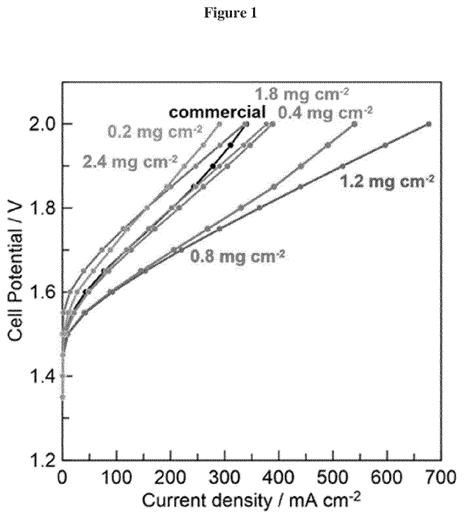

FIG. 1: Shows polarization curves recorded at room temperature on the catalyst membrane of present invention and a commercial CCM. The labelled loadings correspond to Ir loadings (0.2 to 2.4 mg/cm²). The commercial CCM consists of a 2 mg cm⁻² IrRuOx anode.

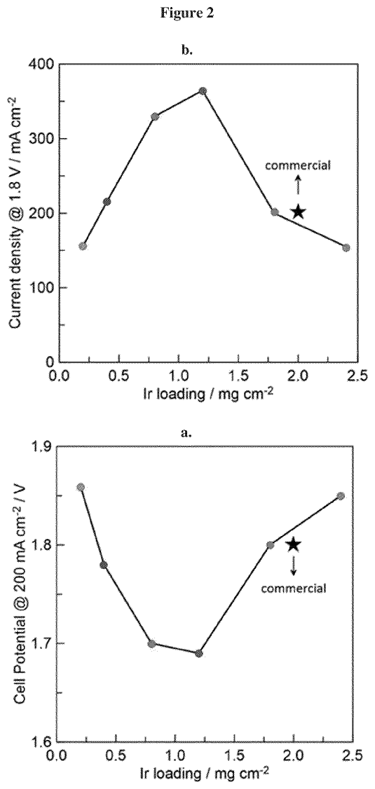

FIG. 2: Shows the effect of Ir loading of the catalyst membrane of present invention on;
(a) the cell potential required to drive a current density of 200 mA cm⁻², and
(b) the current density obtained under constant cell polarization at 1.8 V.

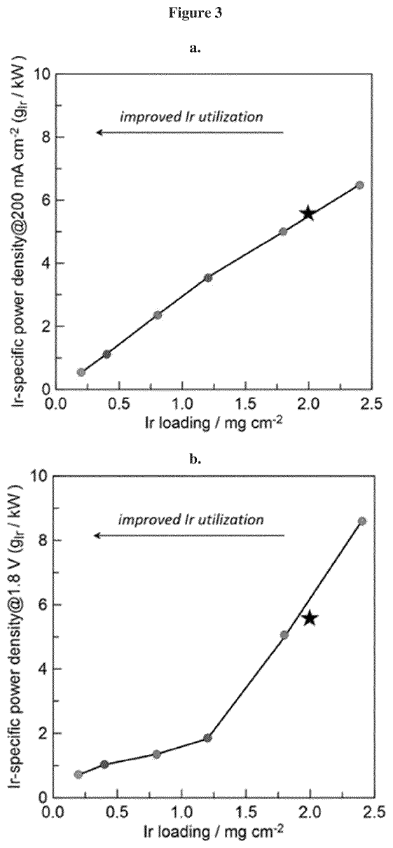

FIG. 3: Shows the effect of Ir loading on the Ir-specific power density of the catalyst membrane of present invention when operated;
(a) at constant current density of 200 mA cm⁻² and
(b) under constant cell polarization at 1.8 V. The calculations for the commercial CCM took into account the total amount of PGM metals (Ir+Ru).

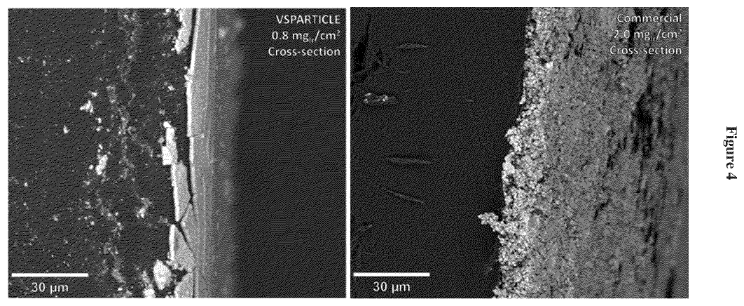

FIG. 4: Shows Scanning Electron Microscope images of Ir layer thickness and density on the catalyst membrane of present invention (left, 0.8 mg/cm²) and a commercial sample (right, 2 mg/cm2).

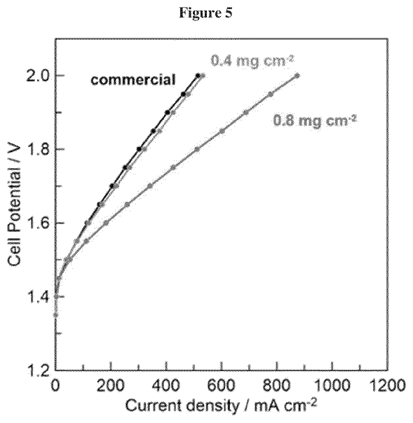

FIG. 5: Shows polarization curves recorded at 60° C. on the catalyst membrane of present invention and a commercial sample. The labelled loadings correspond to Ir loadings, 0.4, and 0.8 mg/cm². The commercial CCM consists of a 2 mg/cm² IrRuOx anode.

### EXAMPLES

### Example 1—Preparation of Ir-Based Membrane Electrode Assemblies (MEAs) via Spark Ablation and Gas-Phase Deposition Onto Nafion Membranes

Five different catalyst membranes (CCMs) (sample 1 to 5) are manufactured according to the method of present invention; Ir-based materials prepared with spark ablation having different thickness (thus Ir loading). A square deposition region of 2.0×2.0 cm was achieved by depositing a constant stream (i.e. fixed voltage, current, and gas flow) of nanoparticles directly onto the membrane through nozzle, and moving the nozzle relative to the substrate using a scripted deposition protocol with a constant printing speed. Different metal loadings were obtained by changing the printing speed while maintaining identical Ir output settings for the nanoparticle generator, with higher print speeds yielding shorter print times and therefore lower metal loadings.

Sample 1: Polymer membranes (Nafion 115 membranes (4.0 cm×4.0 cm×0.125 mm, FuelCellEtc) were fastened onto a substrate holder in a vacuum chamber, and said vacuum chamber was evacuated to a pressure of 1 mbar. Ir nanoparticles were prepared using a spark ablation nanoparticle generator (VSP-G1, VSParticle) fitted with Ir electrodes (3 mm diameter, 99% Ir) and deposited onto Nafion-115 membranes by inertial impaction. The VSP-G1 employed 13 W (1.3 kV, 10 mA) with 2.0 L/min Ar flow. The nanoparticle stream was brought through a nozzle (d=0.35 mm) into said vacuum chamber, while maintaining the pressure at 1 mbar. A deposition region of 2.0×2.0 cm was achieved by moving the substrate under the nozzle in the XY plane, in this manner depositing nanoparticles in 100 parallel lines at a fixed printing speed. The length of each line was 20 mm, yielding a total printing length of 2000 mm. A printing speed of 200 μm/s was employed to achieve a Ir loading of 0.4 mg/cm².

Sample 2: Identical method as sample 1, with the difference of a printing speed of 80 μm/s was employed to achieve a Ir loading of 0.8 mg/cm².

Sample 3: Identical method as sample 1, with the difference of a printing speed of 60 μm/s was employed to achieve a Ir loading of 1.2 mg/cm².

Sample 4: Identical method as sample 1, with the difference of a printing speed of 40 μm/s was employed to achieve a Ir loading of 1.8 mg/cm².

Sample 5: Identical method as sample 1, with the difference of a printing speed of 30 μm/s was employed to achieve a Ir loading of 2.4 mg/cm².

TABLE 1
Sample specifications Sample 1 to 5 for Ir-based
materials prepared with spark ablation.

| | Active area | Total printing length | Print speed | Ir loading |
|---|---|---|---|---|
| Sample | (cm²) | (mm) | (μm/s) | (mg/cm²) |
| Sample 1 | 4.0 | 2000 | 200 | 0.4 |
| Sample 2 | 4.0 | 2000 | 80 | 0.8 |
| Sample 3 | 4.0 | 2000 | 60 | 1.2 |
| Sample 4 | 4.0 | 2000 | 40 | 1.8 |
| Sample 5 | 4.0 | 2000 | 30 | 2.4 |

The membrane electrode assemblies (comprising sample 1 to 5) were completed by interfacing Pt cathodes to the other side of the nafion membrane of the samples 1 to 5 (Pt—C on Carbon Cloth, 4 mg Pt cm², supplied by FuelCellsEtc). A platinized Ti screen (FuelCellsEtc) was used for the anode's current collection. The membrane electrode assembly was loaded to a single in-house built 4 cm² PEM electrolyser equipped with Ti-bipolar plates. The operating temperature was monitored using a K-type thermocouple and controlled with an Omega CN16DPT-144-EIP temperature controller. Deionized water was supplied with a flowrate of 10 ml/min to the anodic and cathodic compartments using a dual-channel peristaltic pump (Masterflex C/L). Electrochemical data was collected using a Vertex potentiostat/galvanostat (Ivium Technologies). polarization curves were obtained by holding constant potential steps of 3 min duration.

### Example 2—Performance Screening of Various CCMs With Different Ir Loadings

The performance screening of various CCMs with different Ir loadings obtained in example 1 was performed. The performance screening was done at room temperature electrolysis and the Ir loading was in the range of 0.4-2.4 mg cm2. Similar experiments were performed with a commercial state-of-the-art CCM with an IrRuOx anode with 2 mg cm2 loading. The polarization curves were recorded at room temperature with the various CCMs prepared (see FIG. 1). The current density (which is representative of hydrogen production rate) at a given potential is increasing as the Ir loading in the CCM increases from 0.2 to 1.2 mg cm-2, while it decreases again upon further increase in the Ir loading (1.8 and 2.4 mg cm-2). Taking into account that the active sites for the reaction are located at the catalyst/membrane/water interface, the observed decrease in the activity could be attributed to the blocking of active sites at higher amounts of deposited Ir. The polarization curve obtained with a commercial membrane electrode assembly (2 mg cm-2 IrRuOx) is also given in FIG. 1 for comparison reasons. It is clearly shown that the VSP-CCMs outperform the commercial CCM with using less amounts of Ir.

To enable an improved comparison, FIGS. 2a and 2b were constructed based on the polarization data of FIG. 1. FIG. 2a illustrates the potential needed (indicative of the energy needed) to drive electrolysis with a certain rate of 200 mA/cm2. FIG. 2b illustrates the current density (indicative of hydrogen production rate) obtained when the cell is polarized at a constant potential of 1.8 V. These figures show the great potential of the method of present invention to produce highly active CCMs with reduced Ir loadings in comparison to the known commercial CCM.

To quantify the Ir utilization in the CCMs, the Ir-specific power density was used as a descriptor. Low values of this parameter indicate that less amount of Ir is needed to drive electrolysis with a specific power density. Values for the Ir-specific power density were calculated both for cell operation at a specific current density (200 mA cm-2, FIG. 3a) and at a specific applied potential (1.8 V, FIG. 3b). FIG. 3 a, b suggest that the method of present invention is able to produce CCMs with improved Ir utilization, since the Ir-specific power density with VSP-CCMs (0.2-1.8 mg cm-2 Ir loading) can be reduced by up to an order of magnitude compared to the known commercial CCM.

To assess the activity of the CCMs two more performance indicators were used, based on the EU Harmonized Protocols for testing low temperature water electrolysers [Tsotridis, G. and Pilenga, A., “EU harmonised protocols for testing of low temperature water electrolysers”, DOI: 10.2760/58880]. The energy efficiency (å) is defined as the ratio of the amount of total energy required for splitting 1 mol of water under reversible conditions and the actual amount of energy (electricity and heat) used in the process, including the energy needed to overcome irreversibilities). The energy efficiency of a single cell, å_{cell} can be expressed as:

$${ε}_{cell} = \frac{DG}{DH} = 1 - T \frac{D S}{D H} = \frac{n \cdot F \cdot {U}_{t n}}{n \cdot F \cdot {U}_{cell} + {Q}_{i n p u t}}$$

where U_{cell} is the measured cell voltage and Qᵢₙₚᵤₜ is the heat supplied to the cell by an external source. According to thermodynamics, the thermoneutral potential (Uₜₙ) equals to 1.48 V at standard conditions and Qᵢₙₚᵤₜ equals to zero when the cell operates at potentials higher than the Uₜₙ.

The Specific Electricity Consumption (SEC) is expressed in kWh Nm³_{H2} and it is indicative of the electric energy required for producing 1 Nm³ (or equivalently 1 kg) of hydrogen. In our case the SEC was calculated taking into account cell operation at 200 mA cm-2 current density. The SEC is expressed as:

$$S E C = \frac{P cell @ 200 mA / cm 2}{rate of H 2 production @ 200 mA / cm 2}$$

P_{cell} is the power input to the cell. Assuming 100% Faraday Efficiency (no current losses) the rate of H₂ production at 200 mA cm⁻² is 3.6×10⁻⁴ Nm³ h⁻¹. Table 2 presents the four performance indicators we used to assess the activity of the VSP-CCMs, including key physical properties. The Ir layer thickness on the catalyst-coated membranes of present invention and commercial sample was measured by Scanning Electron Microscope (SEM), see also FIG. 4.

TABLE 2
Key physical properties and performance indicators for cell operation at 200 mA/cm² of commercial
(Comm. CCM) and catalyst-coated membranes (CCM) of present invention (Sample 1 to 5).

| | | | | | | at 200 mA/cm² | | | |
|---|---|---|---|---|---|---|---|---|---|
| | | | | | Layer | | | | Ir-specific |
| | | Particle | | Layer | thickness | | | SEC | power |
| | Ir loading | size | Particle | thickness | density | Potential | ε_{cell} | (kWh | density |
| | (mg/cm²) | (nm) | morphology | (μm) | (g_{Ir}/cm³) | (V) | (%) | nm⁻³) | (g_{Ir} kW⁻¹) |
| Com. CCM | 2.0 | ~5 | Crystalline | ~8 | 2.5 | 1.80 | 82.2 | 4.0 | 5.50 |
| Sample 1 | 0.4 | 2 | Amorphous | 1 | 4.0 | 1.78 | 83.1 | 3.9 | 1.12 |
| Sample 2 | 0.8 | 2 | Amorphous | 1.4 | 5.7 | 1.70 | 87.1 | 3.8 | 2.35 |
| Sample 3 | 1.2 | 2 | Amorphous | n.m. | n.m. | 1.69 | 87.6 | 3.7 | 3.55 |
| Sample 4 | 1.8 | 2 | Amorphous | 5 | 3.6 | 1.80 | 82.2 | 4.0 | 5.01 |
| Sample 5 | 2.4 | 2 | Amorphous | 6.7 | 3.7 | 1.85 | 80.0 | 4.1 | 6.48 |

Taking into account the demands for practical application, for operation at a specific current density, the applied potential, the specific electricity consumption and the Ir-specific power density should be as low as possible, while the energy efficiency should be high. Based on these criteria, the CCMs of present invention with Ir loading of 0.4 and 0.8 mg cm⁻² were identified as the most promising ones for follow-up studies. FIG. 4 presents the polarization curves obtained with the two most promising CCMs of present invention during water electrolysis at 60° C. The Ir-specific power density is significantly reduced (1.19 gIr/kW for the 0.4 mg cm⁻² CCM, 2.45 gIr/kW for the 0.8 mg cm⁻² CCM) compared to the commercial (5.88 gIr/kW).

Stability and durability testing of the samples showed acceptable results for the stability, and good results for durability.

### Further Embodiments

The proton exchange membrane (PEM) used in the present patent disclosure may be based on a polysulfonic acid material such as those sold commercially under the names Aquivion® and Nafion®. Other proton exchange membranes may be used. Materials for the proton exchange membrane that can be used to carry out the present invention may be perfluorocarbonsulfonic acid or polysulfonic acid polymers (such as those sold commercially under the names: Nafion®, Aquivion®, Fumapem®-F, Fumapem® SX Pemion®), polybenzimidazole membranes (notably for possible high temperature use) such as those sold commercially under the names: Celtec®, Fumapem® AM, Fumapem® ST, polyacrylic acids, and hydrocarbon membranes (such as those sold commercially under the names commercial names: Fumatech® ST, Fumatech® P, E). Preferred materials for the proton exchange membrane are: perfluorocarbonsulfonic acid or polysulfonic acid polymers, or polyacrylic acids, most preferred being perfluorocarbonsulfonic acid or polysulfonic acid polymers.

The present invention is also applicable in the field of the anion exchange membranes (AEM). AEM materials containing quaternary ammonium groups (such as those sold under the commercial names: Fumasep® FAA, A201, Orion® TM1, Durion®, Selemion®) or low density polyurethane with quaternary ammonium groups; anion exchange membrane materials containing imidazolium or polybenzimidazole groups (such as those sold under the commercial names: Aemion®, Sustainion®), or tri-or di-amine cross-linked quaternized polysulfones. Preferred anion exchange membrane materials are ones containing quaternary ammonium groups, low density polyurethane with quaternary ammonium groups, or anion exchange membrane containing imidazolium or polybenzimidazole groups. A particularly preferred choice is the use of anion exchange membranes based on materials with vinylbenzyl chloride and imidazolium groups (such as those sold under the commercial name: Sustainion®). Low-density polyethylene (LDPE) including grafted LDPE is another preferred option.

1-29. (canceled)

30. A method of manufacturing a catalyst membrane, the method comprising the steps of;
providing a membrane;
generating an aerosol of catalyst nanoparticles by spark ablation; and
directing the aerosol of catalyst nanoparticles towards a first side of the membrane such that the catalyst nanoparticles are deposited onto the membrane thereby forming the catalyst membrane.

31. The method according to claim 30, wherein the spark ablation is performed by at least one spark generator.

32. The method according to claim 30, wherein the membrane is an ion conducting polymer, wherein the membrane is configured to conduct hydrogen ions, hydroxide or hydronium ions.

33. The method according to claim 30, further comprising, after generating the aerosol of catalyst nanoparticles, allowing the aerosol of catalyst nanoparticles to pass through a nozzle, wherein the directing of the aerosol of catalyst nanoparticles towards the membrane is directing the aerosol of catalyst nanoparticles passed through the nozzle towards the membrane.

34. The method according to claim 33, wherein the aerosol of catalyst nanoparticles is accelerated through the nozzle into a vacuum downstream of the nozzle, wherein a gas pressure upstream of the nozzle is in the range of 0.8 to 1.4 bar, and/or wherein the pressure of the vacuum downstream of the nozzle is in the range of 0.1 to 4 mbar.

35. The method according to claim 34, wherein the pressure at the inlet of the nozzle is below 900 mbar.

36. The method according to claim 30, wherein the catalyst nanoparticles are attached directly to the membrane in a binder-free manner,

37. The method according to claim 30, wherein the catalytic nanoparticles are comprised of one or more elements selected from the group consisting of Ir, Pt, Ru, Rh, Au, Ag, Ni, Fe, Co, Ti, C, Mo and Mn and/or oxides thereof.

38. The method according to claim 30, wherein the catalyst nanoparticles are amorphous nanoparticles having an average particle size in the range of 0.5 nm to 10 nm.

39. The method according to claim 36, wherein the iridium is deposited such that a catalytic layer is formed having a mass per unit area in the range of 0.2 to 1.8 mg Ir/cm².

40. The method according to claim 30, wherein the generated aerosol of catalytic nanoparticles is passed through a filter.

41. The method according to claim 33, wherein the generated aerosol of catalytic nanoparticles is passed through a filter, and wherein the aerosol of catalytic nanoparticles is passed through the filter before passing through the nozzle.

42. The method according to claim 30, further comprising attaching a porous transport layer to the first side of the catalyst membrane, wherein the porous transport layer is electrically conductive, thereby forming a membrane electrode assembly.

43. A catalyst membrane manufactured according to the method of claim 30.

44. A catalyst membrane comprising:
a membrane, and
catalyst nanoparticles attached directly to the membrane in a binder-free manner,
wherein the catalyst nanoparticles are metal nanoparticles or metal oxide nanoparticles.

45. The catalyst membrane according to claim 44, wherein the membrane is an ion conducting membrane, wherein the membrane is an ion conducting polymer selected from the group consisting of polysulfonic acid polymers, perfluorocarbonsulfonic acid polymers, polyacrylic acid polymers.

46. The catalyst membrane according to claim 44, wherein the catalytic layer comprises iridium with a mass per unit area in the range of 0.2 to 1.8 mg Ir/cm².

47. The catalyst membrane according to claim 44, wherein the catalyst nanoparticles have an average particle size in the range of 0.5 nm to 10 nm.

48. A membrane electrode assembly comprising the catalyst membrane according to claim 44.

49. A use of the catalyst membrane or membrane electrode assembly according to claim 44 for water electrolysis.
